(19) United States
(12) Patent Application Publication
(10) Pub. No.: US 2003/0021271 A1
(43) Pub. Date: Jan. 30, 2003

(54) Hybrid wireless communication system

(76) Inventors: Donald K. Leimer, Rancho Palos Verdes, CA (US); Charles R. Cahn, Manhattan Beach, CA (US); Steven P. Chen, Cerritos, CA (US); James R. Luecke, Mission Viejo, CA (US); Adam Efron, Los Angeles, CA (US)

Correspondence Address: IRELL & MANELLA LLP, Suite 900, 1800 Avenue of the Stars, Los Angeles, CA, 90067, US

(21) Appl. No.: 09/825,323

(22) Filed: Apr. 3, 2001

(51) Int. Cl. H04L 12/56

(52) U.S. Cl. 370/390; 370/535

(57) ABSTRACT

A wireless network of multiple base stations, each communicating with multiple remote terminals, exhibiting simpler design and enhanced inter-user and inter-base interference rejection. The downlink from a base to the multiple remote terminals employs a combination of time division multiplexing (TDM) and time division multiple access (TDMA) to multiplex signals carrying data to the remote terminals, and spreads the multiplexed signal with a pseudo-random noise (PN) sequence. The uplink from each remote terminal to the respective base uses orthogonal code division multiple access (O-CDMA) coding to multiplex a variable number of channels for each remote terminal. Short O-code sequences are derived based on pseudo-random maximal length sequences and quadratic residue sequences to introduce sufficient randomness into the multiple access coding to reject inter-base interference without the use of PN signal spectrum spreading.

### BACKGROUND OF THE INVENTION

1. Field of the Invention

The present invention relates to the field of fixed, wireless communication systems, and in particular to a hybrid modulation technique for point to multi-point communications between a series of base stations and a plurality of sets of fixed remote users, each set communicating directly with one of the base stations for connection to a wide area network such as the Internet.

2. Description of the Prior Art

A new information revolution has created a burgeoning demand for network communications. Multimedia services, including the Internet, have emerged as exceptional new sources for distribution of video, voice and data information having business, educational and cultural content. Recent deregulation by the United States Government has opened new competition in local network access markets. Technologies providing the so-called “last mile” network connection to millions of domestic households have become one of the fastest growing fields in telecommunications. Traditionally, the “last-mile” market was dominated and divided by incumbent local telephone companies for voice service and cable television operators for video service. This situation has dramatically changed as a result of the recent, explosive growth in Internet usage. With data and services migrating toward “digitized” or “digital” communication, a full, packet-based network with integrated video, voice, and data is close to reality. As a result of this trend, through innovative network architectures with new wired or wireless solutions, service providers could offer many alternatives to traditional services.

Wireless networks became popular in the 1990's initially in order to serve mobile users. However, the same or similar technology can be used to provide wireless Internet access for fixed users; the advantage of wireless over wired access methods like cable and direct subscriber lines (DSL) is that wireless networks can be deployed more quickly and potentially at lower cost. In order to serve homes and small businesses, the network must be designed to support a large number of users in the limited spectrum available for fixed wireless services. It must be implemented at low cost. Thus cost and capacity are primary considerations in setting up an economically viable, wireless access scheme for home and small business users.

The problem of providing a relatively inexpensive method and system for access by fixed users of multimedia services through a shared spectrum, particularly one having a wide band, wireless link, has presented a major challenge to the telecommunications industry.

Conventional techniques include many variations of both TDMA and CDMA approaches to point to multi-point communications, each of which has its own particular limitations including problems with bandwidth, data rate, interference and costs to produce, install and operate.

What is needed is an approach to providing such communications that balances the advantages and disadvantages to known techniques to provide a robust wideband and inexpensive installation.

### SUMMARY OF THE INVENTION

In accordance with a first aspect of the present invention, a method of wideband communication between a base station and a plurality of remote terminals within each cell of a multicell network is provided in which a downlink data stream from the base station to the remote terminals is modulated in a plurality of channels that are time division multiplexed into a downlink signal that is subsequently spread with a pseudo-random noise signal to form a broadcast signal; and an uplink data stream from each remote terminal is modulated in one or more channels that are each then spread with an orthogonal code and summed to form an uplink signal for synchronous transmission with the other terminals in the cell to the cell base station.

In another aspect, the present invention provides a wideband multi-cell network, wherein each cell includes a base station and a plurality of remote terminals; each base station having logic for processing an input data signal for broadcast to remote terminals in the same cell comprising a demultiplexer for demultiplexing the input data signal into a plurality of channels, a plurality of modulators for modulating a portion of the input data signal in each channel, a multiplexer for time division multiplexing each modulated channel to form an output data signal, a multiplier for spreading the output data signal with a pseudo-random noise signal to form a broadcast signal, and a RF system for broadcasting the broadcast signal to be received by the plurality of remote terminals within the same cell; and each remote terminal having logic for processing a data signal for transmission to the base in the same cell comprising a demultiplexer for demultiplexing the data signal into one or more channels, a modulator in each channel for modulating a portion of the data signal in each channel, a multiplier for spreading each modulated channel with an orthogonal code to form an orthogonal signal, an adder for summing a predetermined number of the orthogonal signals to form a terminal signal, and logic for scheduling the terminal signal for transmission by the remote terminal to be received by the base station in the same cell synchronously with terminal signals from other remote terminals in the same cell.

### BRIEF DESCRIPTION OF THE DRAWINGS

FIG. 1 is a block diagram of a point to multi-point, broadband network according to the present invention;

FIG. 2 is a schematic diagram of an embodiment of one frame of time division duplex (TDD) data traffic carried on the network of FIG. 1;

FIGS. 3a and 3b is an expanded, schematic view of the time frame of FIG. 2, showing downlink and uplink segments further divided into time slots during which packets of data are transmitted;

FIGS. 4a and 4b is a block diagram of an embodiment of the transmission logic for the base station of FIG. 1;

FIG. 5 is a block diagram for a convolutional encoder for use in the transmission logic of FIG. 5;

FIG. 6 is a block diagram for an interleaver for use in the transmission logic of FIG. 5;

FIG. 7 is a schematic diagram of signal constellations available to QPSK, QAM8 and QAM16 modulation processes for use in the transmission logic of FIG. 5; and

FIG. 8 is a block diagram of an embodiment of the transmission logic for a remote terminal as shown in FIG. 1.

### DETAILED DESCRIPTION OF THE INVENTION

A broadband wireless access (BWA) system, according to the present invention, uses a traditional cellular structure, consisting of multiple base stations or cell sites, each serving a plurality of remote terminals in its coverage area. Each base station may be connected to one or more networks such as the Internet backbone, telephone, television, etc. in a variety of ways.

The present invention utilizes a first modulation technique in the downlink direction from the base stations to the remote terminals and a second, different modulation technique in the uplink direction from the remote users to the base stations.

In a preferred embodiment, the downlink from a base station to multiple remote terminals may use a single data channel or data stream. The single data stream may be de-multiplexed into a number of encoding and modulation channels related to the number of remote terminals, such as 32. The modulation channels are quadrature phase shifted (QPSK) or quadrature amplitude modulated (QAM). Time division multiplexing (TDM) is then used to combine the channels for transmission. The combination of the channels is filtered and spread with a pseudo-random noise (PN) signal prior to transmitting in a time division duplexing (TDD) scheme.

In accordance with the present invention, one or more data channels may be assigned to any one user and transmitted on the uplink from the remote terminal to the respective base station in a synchronous, orthogonal code division multiple access (O-CDMA) scheme within allocated time slots to serve multiple users. The codes employed are short (relative to the long PN code sequences) orthogonal sequences that eliminate interference between the different user signals received synchronously at the base station, and that provide sufficiently low cross-correlation with signals received from users communicating with neighboring bases to also minimize or eliminate inter-base interference. This technique differs from conventional CDMA techniques in that a PN code is not used to spread the frequency of the uplink transmissions.

In accordance with the present invention, the forward links and return links, that is, the downlinks and uplinks, operate on the same carrier frequency, using time division duplexing (TDD). Because the forward and return link waveforms are relatively similar in structure to each other even though different modulation schemes are used, the implementation of the chipsets used in equipment for both directions of propagation becomes almost identical, leading to economies of scale, which can be passed on to the ultimate users.

Encoding used in both downlink and uplink directions can be either convolutional, as proposed in a preferred embodiment, or an alternate error-correction code. Each of these codes has advantages and disadvantages, mainly in terms of trading coding gain for complexity and delay.

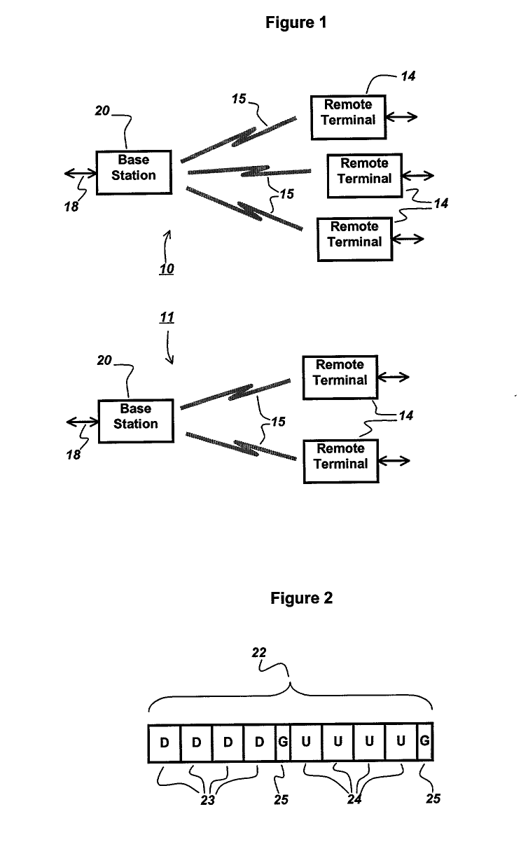

With reference now to FIG. 1, a pair of cells 10 and 11 are shown in accordance with the present invention. In a point-to-multipoint wireless network cell according to the invention, all remote terminals 14 in one particular cell 10 share the inbound or uplink segment of wireless link 15 with their assigned base station 20. Cell 11 may be configured in the same manner as cell 10. The base station 20 of each of a plurality of cells is further connected to the Internet or other network through link 18. Wireless link 15 may include a single wireless channel that is time shared between downlink segment and the uplink segment using time division duplexing (TDD). Downlink communications to each of the remote terminals 14 is accomplished through a combination of TDM and TDD on the wireless channel, and uplink communications from each remote terminal shares the channel using a combination of TDMA and O-CDMA. The downlink from the base modulates a single carrier signal that is broadcast to all remote terminals, and each remote terminal uplink modulates its own carrier signal thus resulting in multiple uplink carriers.

Referring now to FIG. 2, the underlying modulation of signals in both the uplink 24 and downlink 23 segments of link 15 can be selected by a network management process based on traffic, signal-to-noise, and interference conditions on the link 15. The modulation methods used in a preferred embodiment include quadrature phase shift keying (QPSK) with rate-½ and rate-¾ convolutional coding; 8-ary quadrature amplitude modulation (8QAM) with encoding rate ⅔; and 16-ary quadrature amplitude modulation (16QAM) with encoding rate ¾. However, it is clear that, if even higher capacity is desired, higher-order modulation schemes (such as 64-ary QAM or other) can be used as well.

FIG. 2 shows one time frame 22 of TDD traffic carried on the wireless link 15. The time frame 22 is divided into a downlink segment 23 and an uplink segment 24. The duration of the downlink segment 23 and uplink segment 24 can be varied from one time frame 22 to the next to adapt to the data flow requirements within the cell.

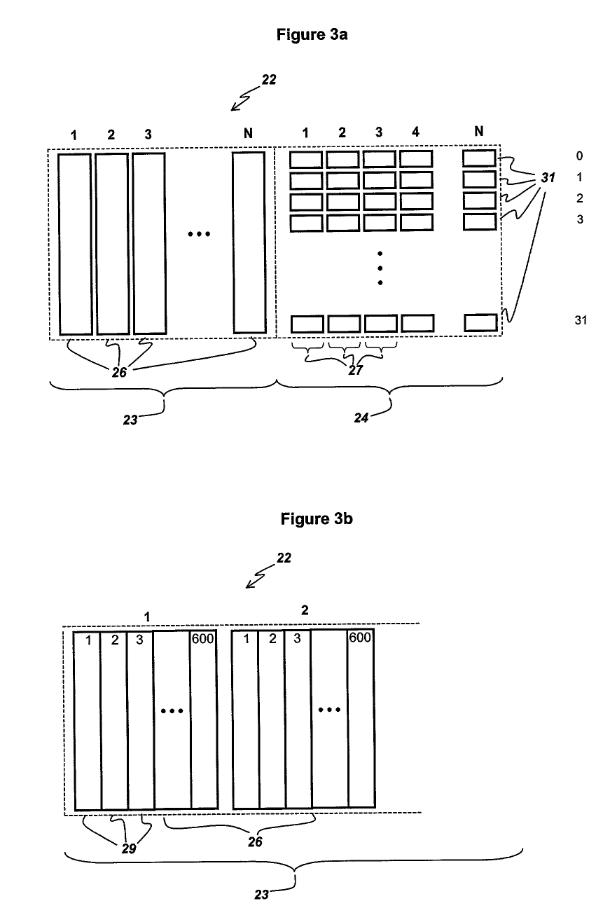

Referring now also to FIG. 3a, each segment 23, 24 is further divided into time slots 26 and 27, respectively, during which packets of information are transmitted. Downlink signals are broadcast by base 20 to all remote terminals 14 assigned to the base 20, and each downlink time slot 26 carries the multiplexed data channels for a preselected number of remote terminals.

With reference now to FIG. 3b, the data broadcast during each downlink time slot 26 is time division multiplexed (TDM) between all the remote terminals to which the particular downlink slot period is addressed. In an exemplary embodiment wherein QPSK, rate-½ modulation is employed, each downlink segment 23 may be divided into a maximum of N=7 downlink time slots 26; each time slot may then be further divided into 24 synchronization time periods and 576 data time periods. Each downlink data time period 29 may then be divided into 32 pulse positions, each of which carries a symbol corresponding to a modulated data word processed by one of the code channels 48 (see discussion below). Each symbol may carry between 1 to 3 information bits depending upon the modulation scheme employed.

Each pulse position thus carries data for one of the 32 data channels 48, and thus the 32 user data channels are time division multiplexed (TDM) within each downlink data time period 29. The signal broadcast by the base and carried on the downlink is received continuously by all remote terminals, and each individual remote terminal extracts its intended data bits from the received signal.

With reference now again to FIG. 3a, each uplink time slot 27 is further divided into a plurality of orthogonal code channels 31, preferably 32 channels in accordance with the exemplary embodiment being described, corresponding to the remote terminals assigned to the particular time slot period. The remote terminals grouped in one such uplink time slot 27 synchronize their TDMA transmissions to transmit only during their assigned uplink time slots such that their signals are received at the base station synchronously to be aggregated into a multiplexed received signal for demultiplexing.

Each time slot 26, 27 includes a synchronization portion followed by a data portion (e.g. the 24 synchronization time periods and 576 data time periods mentioned above and shown in FIG. 3b). The allocation of the downlink 23 and uplink 24 frame-segment boundaries is flexible and can be varied by the network planner or administrator based on any detected asymmetry of the traffic demand. Guard-time intervals 25 (as shown in FIG. 2) are inserted between the downlink-uplink and uplink-downlink transitions to eliminate interference between the links due to finite delays of signal propagation.

The waveform parameters used in a preferred embodiment are summarized for the downlink 23 and uplink 24 segments in Table 1. A frame length of 7.5 milliseconds provides 2,025 chips to be used for guard intervals between the downlink 23 and uplink 24 segments.

TABLE 1
A Preferred Time Frame Structure

| Parameter/ | QPSK; | QPSK; | QAM8; | QAM16; |
|---|---|---|---|---|
| modulation | r = ½ | r = ¾ | r = ⅔ | r = ¾ |
| method | | | | |
| Bps/Hz | 1 | 1.5 | 2 | 3 |
| Slot size (bytes) | 72 | 72 | 72 | 72 |
| Slot size (bits) | 576 | 576 | 576 | 576 |
| Slot size (symbols) | 576 | 384 | 288 | 192 |
| Synch bytes | 3 | 3 | 3 | 3 |
| Synch symbols | 24 | 16 | 12 | 8 |
| Total symbols | 600 | 400 | 300 | 200 |
| Slots/frame | 8 | 12 | 16 | 24 |
| Chip rate (Mcps) | 20.75 | 20.75 | 20.75 | 20.75 |
| Aggregate data rate | 20.48 | 30.72 | 40.96 | 61.44 |
| (Mbps) | | | | |
| Frame length (ms) | 7.5 | 7.5 | 7.5 | 7.5 |

Downlink

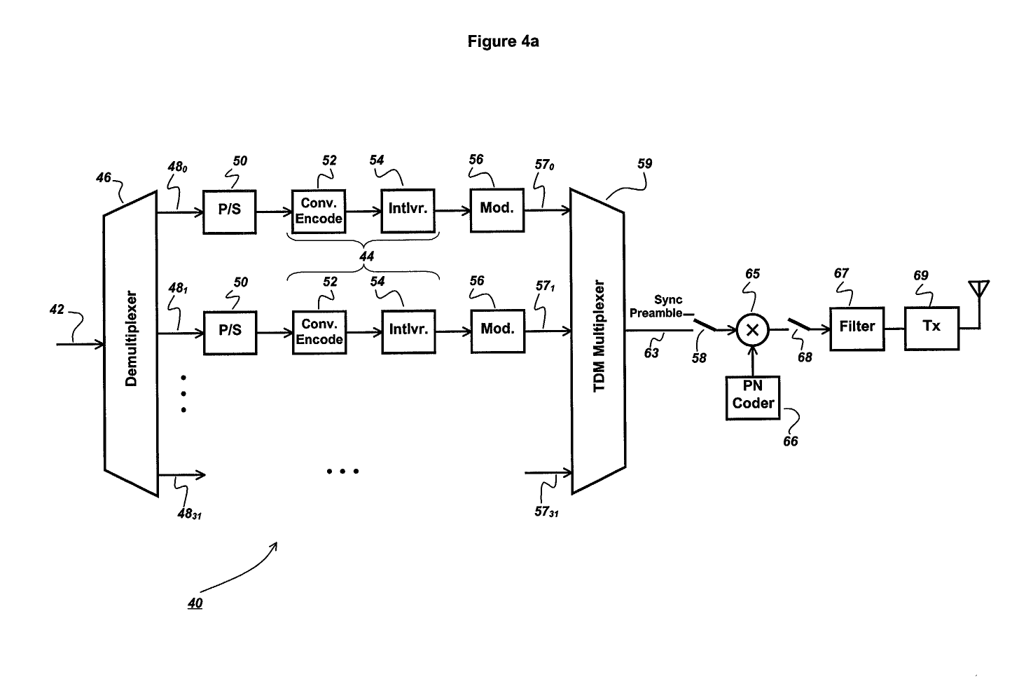

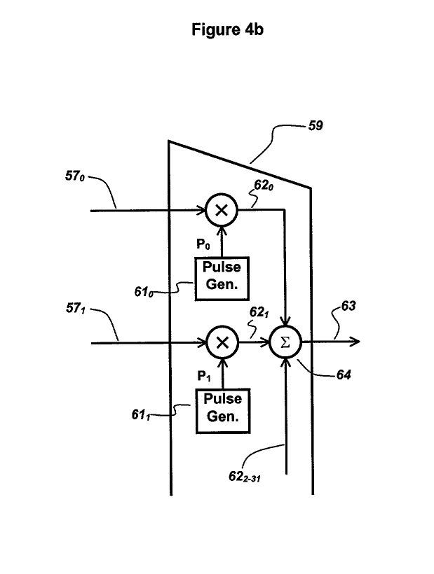

FIG. 4a is a block diagram depicting the preferred transmission logic 40 for one base station 20, as shown in FIG. 1. The transmitter logic 40 consists of a plurality of code channels 48₍₀₋ₙ₎, preferably 32 such channels, that are summed together, filtered, and up-converted to an RF carrier. The input 42 to the transmission logic 40 is a single 32-bit word stream of time division multiplexed packets. The word stream is de-multiplexed by demultiplexer 46 into the code channels 48₍₀₋₃₁₎. Each code channel 48 processes a block of six N-bit (in the preferred embodiment, 32-bit) words, or 24 bytes, before the demultiplexer 46 switches to the next code channel 48. Each channel 48 converts each 32-bit word into a bit stream through parallel-to-serial converter 50 for subsequent forward error correction (FEC) 44, the preferred embodiment being convolutional encoding, and interleaving. The convolutional encoder 52 has a preferred constraint length of 9 and an encoding rate of ½. Certain encoded bits are deleted to produce encoding rates of ⅔ and ¾. The interleaver 54 buffers the encoded bits for the modulator 56, which uses the buffered bits to form QPSK, 8QAM, 16QAM, or other modulated symbols. The modulated symbols 57₍₀₋₃₁₎ at the output of each channel are next passed to the TDM multiplexer 59, which outputs a multiplexed signal 63. Multiplier 65 spreads multiplexed signal 63 with a PN code sequence provided by PN code register 66. Filter 67 next filters the spread signal with preferably a square-root, raised-cosine response having 25% excess bandwidth, and RF section 69 then converts the filtered signal to RF for transmission. TDMA switch 68 schedules the spread signal for transmission within downlink segment 23.

With reference now also to FIG. 4b, the TDM multiplexer 59 receives the 32 modulated symbols 57₍₀₋₃₁₎ from the 32 channels 48₍₀₋₃₁₎ and multiplexes the modulated symbols via pulse generators 61₍₀₋₃₁₎ and summer 64 to form multiplexed signal 63. The 32 pulse generators 61 output values of 1 or 0, in a manner so that only one of the pulse generators is generating a non-zero value at any given time (i.e. pulse position) and each pulse generator has generated a non-zero value for at least one pulse position during the data time period 29.

It will be appreciated that by employing TDM coding, the downlink design of the invention transmits only one channel 48 at a time but at full power for each channel. By transmitting at full power for each channel over each time slot period 26 within the downlink segment 23, the downlink of the invention operates at a much lower peak-to-average power ratio than conventional CDMA coding. Thus, the downlink design of the invention may be practiced using simpler and cheaper RF equipment, including simpler and cheaper power amplifiers. In addition, certain FCC regulations that must be complied with can also be met using such simpler equipment. Furthermore, use of nearly-continuous full power results in increased transmission power on the order of approximately 7.5 dB for QPSK modulation and approximately 5 dB for 16QAM.

Typically all bases would employ the same PN sequence, shifted in time for each base to reduce inter-base interference. To add a measure of randomness, and interference rejection, each base 20 may employ a different PN sequence.

Synchronization Preamble

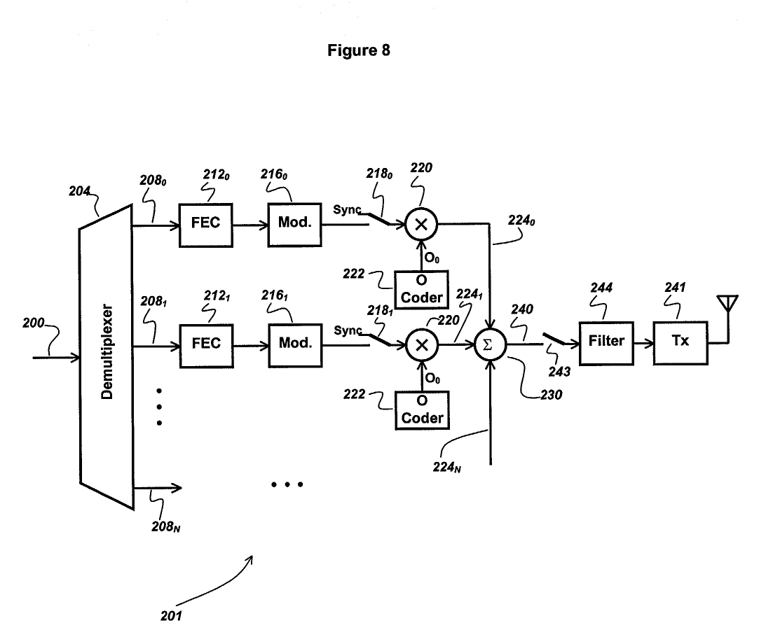

Referring now also to FIG. 4a, a synchronization preamble is added by switch 58 to each time period 29 within multiplexed signal 63. The preamble consists of synchronization symbols that correspond to QPSK modulation symbols for the 00 dibit. For downlink time slot periods 26, all 32 code channels 48₍₀₋₃₁₎ are preferably active for data modulation and only code channel 48₀ is active during the synchronization preamble. As shown in FIG. 8, a sync preamble is also added by switches 218 to each modulated channel of the remote terminals 14 (see uplink discussion below).

Parallel-to-Serial Converter

Referring again to FIG. 4a, parallel-to-serial converter 50 converts each 32-bit word within input signal 42 into a 32-bit long sequence of bits, with the first converted bit of the sequence corresponding to the least significant bit of the word. Six words are converted in succession to create a sequence of 192 bits that are input to each of the convolutional encoders 52. For uplink transmissions 27 as shown in FIG. 3a, the last 8 bits of the 192-bit sequence are set to 0 to “flush” the convolutional encoder 52 to an all-zeroes state. Similarly, the last 8 bits of an entire downlink slot 26 (32×576=18,432 bits) are set to 0 for downlink transmissions.

Convolutional Encoder

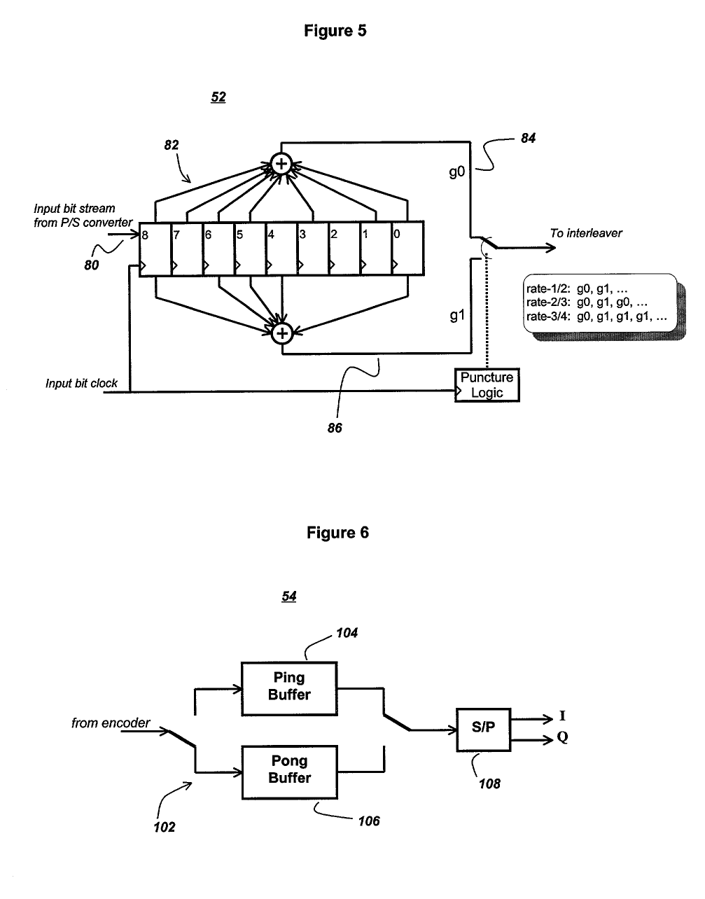

Referring now to FIG. 5, convolutional encoder 52 is depicted in greater detail and may be a rate (r)=½, ⅔ or ¾, constraint length (k)=9 encoder. In each case, two bit streams 84, 86 are generated using the generator polynomials g0=753 (octal) and g1=561 (octal). Encoding rates of ⅔ and ¾ are obtained by puncturing, or deleting, certain bit positions as defined below. For rate-⅔ encoding, the second output bit of the g0 polynomial is discarded for every two input bits. Similarly, the second and third output bits of the g0 polynomial are discarded for every three input bits for rate-¾ encoding.

Interleaver

FIG. 6 shows the block diagram of the interleaver 54, shown in FIG. 4a above. The interleaver 54 includes a “ping-pong” buffer 102 large enough to store up to ⅓ slot of data per code channel. As shown in FIG. 6, the interleaver 54 writes to one third-slot buffer 104 (i.e., “ping”) while reading from the other third-slot buffer 106 (i.e., “pong”). After filling the “ping” buffer 104, it is read, while writing to the “pong” buffer 106. The interleaver 54 reorders the sequence of encoded bits from the convolutional encoder 52 so that the distance between any two consecutive encoded bits is greater than a preferred minimum after reordering. Table 2 shows the minimum distance between any two adjacent encoded bits after being reordered and grouped for modulation.

TABLE 2
Minimum Distance Between Encoded Bits

| | QPSK- | QPSK- | 8QAM- | 16QAM- |
|---|---|---|---|---|
| Characteristic | 1/2 | 3/4 | 2/3 | 3/4 |
| Interleaver buffer | 384 | 256 | 288 | 256 |
| size, | | | | |
| encoded bits | | | | |
| Bits per Symbol | 2 | 2 | 3 | 4 |
| Interleaver buffer | 192 | 128 | 96 | 64 |
| size, | | | | |
| symbols | | | | |
| Minimum distance | 12 | 8 | 12 | 8 |
| within | | | | |
| symbol | | | | |
| Minimum distance | 16 | 16 | 8 | 8 |
| between | | | | |
| symbols | | | | |

The preferred interleaver 54 reorders the sequence of encoded bits using a four-dimensional block interleaver. The encoded bits are written into the appropriate third-slot buffer in the order that they are encoded; i.e., g0, g1, . . . for rate-½ encoding; g0, g1, g1, . . . for rate-⅔ encoding; and g0, g1, g1, g1, . . . for rate-¾ encoding. This sequence is labeled as X₀ to X₃₈₃ for QPSK-½, X₀ to X₂₈₇ for 8QAM-⅔, and X₀ to X₂₅₅ for QPSK-¾ and 16QAM-¾. The output sequence {Xₖ} is reordered by incrementing k from k=0 with four nested loops as follows:

a) increment k by I, modulo M₁;

b) when the increment by I₁, rolls over, increment k by I₂, modulo M₂;

c) when the increment by I₂ rolls over, increment k by I₃, modulo M₄;

d) when the increment by I₃ rolls over, increment k by 1, modulo M₄.

Table 3 defines the preferred values of the interleaver parameters and the resulting output sequence. The serial-to-parallel converter 108 groups the reordered bits for the modulator 56.

TABLE 3
Preferred Interleaver Parameters

| Parameter | QPSK-1/2 | QPSK-3/4 | 8QAM-2/3 | 16QAM-3/4 |
|---|---|---|---|---|
| I₁, M₁ | 12, 24 | 8, 16 | 12, 36 | 8, 16 |
| 12, M₂ | 96, 384 | 64, 128 | 72, 288 | 64, 128 |
| I₃, M₃ | 24, 96 | 16, 64 | 36, 72 | 16, 64 |
| I₄, M₄ | 1, 12 | 1, 8 | 1, 12 | 1, 8 |
| Reordered | X₀, X₁₂, X₉₆, | X₀, X₈, X₆₄, | X₀, X₁₂, X₂₄, | X₀, X₈, X₆₄, |
| Sequence | X₁₀₈, X₁₉₂, X₂₀₄, | X₇₂, X₁₂₈, X₁₃₆, | X₇₂, X₈₄, X₉₆, | X₇₂, X₁₂₈, X₁₃₆, |
| | X₂₈₈, X₃₀₀, X₂₄, | X₁₉₂, X₂₀₀, X₁₆, | X₁₄₄, X₁₅₆, | X₁₉₂, X₂₀₀, X₁₆, |
| | X₃₆, X₁₂₀, X₁₃₂, | X₂₄, X₈₀, X₈₈, | X₁₆₈, X₂₁₆, | X₂₄, X₈₀, X₈₈, |
| | X₂₁₆, X₂₂₈, X₃₁₂, | X₁₄₄, X₁₅₂, | X₂₂₈, X₂₄₀, X₃₆, | X₁₄₄, X₁₅₂, |
| | X₃₂₁, X₄₈, X₆₀, | X₂₀₈, X₂₁₆, X₃₂, | X₄₈, X₆₀, X₁₀₈, | X₂₀₈, X₂₁₆, X₃₃, |
| | X₁₄₄, X₁₅₆, X₂₄₀, | X₄₀, X₉₆, X₁₀₄, | X₁₂₀, X₁₃₂, | X₄₀, X₉₆, X₁₀₄, |
| | X₂₅₂, X₃₃₆, X₃₄₈, | X₁₆₀, X₁₆₈, | X₁₈₀, X₁₉₂, | X₁₆₀, X₁₆₈, |
| | X₇₂, X₈₄, X₁₆₈, | X₂₂₄, X₂₃₂, X₄₈, | X₂₀₄, X₂₅₂, | X₂₂₄, X₂₃₂, X₄₈, |
| | X₁₈₀, X₂₆₄, X₂₇₆, | X₅₆, X₁₁₂, X₁₂₀, | X₂₆₄, X₂₇₆, X₁, | X₅₆, X₁₁₂, X₁₂₀, |
| | X₃₆₀, X₃₇₂, X₁, | X₁₇₆, X₁₈₄, | X₁₃, X₂₅, X₇₃, | X₁₇₆, X₁₈₄, |
| | X₁₃, . . . X₂₈₇, | X₂₄₀, X₂₄₈, X₁, | X₈₅, X₉₇, X₁₄₅, | X₂₄₀, X₂₄₈, X₁, |
| | X₃₇₁, X₃₈₃, | X₉, . . . X₂₃₉, | X₁₅₇, X₁₆₉, | X₉, . . . |
| | | X₂₄₇, X₂₅₅, | X₂₁₇, . . . | X₂₃₉, X₂₄₇, X₂₅₅, |
| | | | X₂₆₃, X₂₇₅, X₂₈₇, | |

Modulator

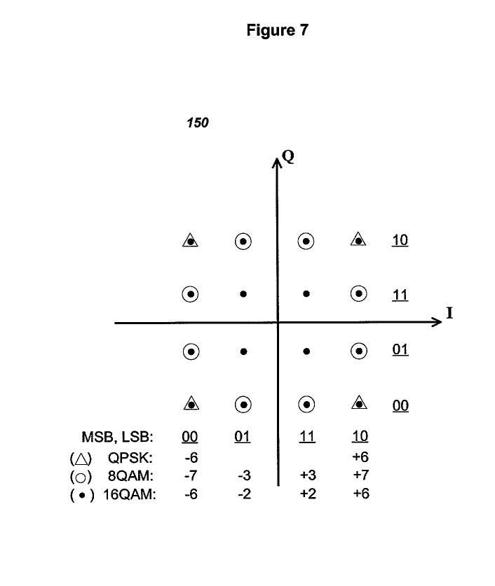

The modulator 56, shown in FIG. 4a above, takes the interleaved bits in groups of 2, 3, or 4 bits, and maps each group to a unique I-Q phasor as defined by the constellations 150 in FIG. 7. For QPSK modulation, the modulator takes interleaved bits in groups of two and maps the first of the two reordered bits to the most significant bit of the in-phase (I) component and the second to the most significant bit of the quadrature-phase (Q) component. The least significant bit of both the I and Q are set to “0” for QPSK, and the four valid constellation points consist of the corners of the square formed by all constellation points 150. For 16QAM modulation, the first and second reordered bits are mapped to the most and least significant bits of the I component, respectively; the third and fourth bits are mapped to the most and least significant bits of the Q component. For 8QAM modulation, the second and first reordered bits are mapped to the most and least significant bits of the Q component, respectively; the third and the complement of the first bits are mapped to the most and least significant bits of the I component.

When the modulator output is converted to RF after filtering, the I component is modulated with a carrier signal that is advanced 90 degrees before the carrier signal that modulates the Q component.

PN-Code Spreader

Referring again to FIG. 4a, the multiplexed signal 63 is further modulated by a long pseudo-random noise (PN) code sequence 66. The long PN code is preferably a maximal linear binary code of length 2²⁰-1, restarted at the beginning of each successive frame 22. In the preferred embodiment, the frame duration is 7.5 milliseconds but can be extended by a factor of four to 30 milliseconds. The chipping rate is 20.75 Mchip per second, and the number of chips in the longest frame is 622,500 chips. Hence, 2²⁰-1 is the shortest maximal sequence to insure unambiguous sync searching over the frame interval.

Uplink

FIG. 8 depicts the preferred transmission logic diagram 201 for one remote terminal 14, as shown in FIG. 1. The remote terminal transmission logic differs from the base 20 transmission logic in several significant aspects, including the use of orthogonal CDMA (O-CDMA) coding and the lack of PN spreading of the transmitted signal. With greater particularity, each remote terminal 14 may be assigned one or more channels 208₀₋ₙ on which to transmit data to the base 20, depending upon the amount and type of data that needs to be transmitted to the base. Upon initiating communication with the base, the remote terminal indicates its data transmission needs, and the base assigns the remote terminal a number of channels upon which to transmit based upon the needs of the requesting remote terminal as well as all other active remote terminals.

Similar to the base 20, the data stream 200 to be transmitted by each remote terminal 14 is a stream of time division multiplexed packets. The stream is demultiplexed by demultiplexer 204 into one or more code channels 208₍₀₋ₙ₎ and processed through FEC 212 and modulator 216 in each code channel. The other processing steps are omitted for simplicity, but it is understood that the process is highly similar to that employed by the base 20 transmission logic. Once each word has been modulated in a respective code channel, a sync preamble is added by switch 218 and the modulated signal is then spread in multiplier 220 with an orthogonal (O) code 222. The O-codes used to spread the channels are orthogonal to each other, and thus exhibit zero cross-correlation for a resultant lack of inter-channel interference. The modulated, orthogonal signals are next summed in summer 230 and the resultant modulated signal 240 is enabled to be transmitted by TDMA switch 243 and filtered 244 before being passed to RF section 241 for transmission to the base 20.

The O-code sequences used to spread the modulated signal on each channel are relatively short (32 bits in the preferred embodiment). It is important to note that PN sequences used in conventional CDMA systems do not typically cross correlate or average to zero within such a short period but rather typically average to zero over relatively much longer periods of time. Thus, further spreading such short orthogonal sequences with a much longer PN sequence, as is typically done in conventional CDMA systems would add a rather limited measure of randomness or “noise” to the transmitted signal and would do little to aid in the rejection of interference.

For uplink transmission, a remote terminal 14 may use up to 32 code channels 208. Each code channel is active for both the synchronization preamble and data-modulation portion of a time slot 27. Up to 32 remote terminals 14 may transmit on different orthogonal code channels 208 during a time slot interval. In an alternative embodiment, remote terminals may be restricted to only one code channel to minimize peak transmitter power.

The O-codes 222 can be generated in real time, but are preferably calculated and stored in memory by both the remote terminals and the bases. Various options are available in selecting O-codes. Walsh codes are perhaps the best-known in the art, and are a class of orthogonal binary sequences of length n, for n equals any power of 2. However, Walsh codes do not have optimum characteristics for use with the invention, because they actually exhibit a certain amount of cross correlation when the channels are phase shifted in time.

Thus, in one preferred embodiment, O-code sequences are generated from a maximal length sequence by the method described below. For generating O-sequences of length 32, 6 sequence matrices may be generated. With reference to Table 4, we begin with a maximal length sequence m1, m2 . . . m31, and add a zero at the end. Next, each successive row is filled in by shifting the sequence to the left, m2, m3 . . . m1, and keeping the zero in the last position. This is continued until the 31^{st} row has been filled in m31, m1 . . . m30, and then the last row is filled in with zeros.

TABLE 4
Maximal length sequence O-code generation.

| | |
|---|---|
| m₁ m₂ m₃ m₄ m₅ m₇ m₈ m₉ m₁₀ m₁₁ m₁₂ m₁₃ m₁₄ m₁₅ m₁₆ m₁₇ m₁₈ m₁₉ m₂₀ m₂₁ m₂₂ m₂₃ m₂₄ m₂₅ m₂₆ m₂₇ m₂₈ m₂₉ m₃₀ m₃₁ | 0 |
| m₂ m₃ m₄ m₅ m₇ m₈ m₉ m₁₀ m₁₁ m₁₂ m₁₃ m₁₄ m₁₅ m₁₆ m₁₇ m₁₈ m₁₉ m₂₀ m₂₁ m₂₂ m₂₃ m₂₄ m₂₅ m₂₆ m₂₇ m₂₈ m₂₉ m₃₀ m₃₁ m₁ | 0 |
| m₃ m₄ m₅ m₇ m₈ m₉ m₁₀ m₁₁ m₁₂ m₁₃ m₁₄ m₁₅ m₁₆ m₁₇ m₁₈ m₁₉ m₂₀ m₂₁ m₂₂ m₂₃ m₂₄ m₂₅ m₂₆ m₂₇ m₂₈ m₂₉ m₃₀ m₃₁ m₁ m₂ | 0 |
| . . . . | |
| . . . | |
| . . | |
| . | |
| m₃₁ m₁ m₂ m₃ m₄ m₅ m₇ m₈ m₉ m₁₀ m₁₁ m₁₂ m₁₃ m₁₄ m₁₅ m₁₆ m₁₇ m₁₈ m₁₉ m₂₀ m₂₁ m₂₂ m₂₃ m₂₄ m₂₅ m₂₆ m₂₇ m₂₈ m₂₉ m₃₀ | 0 |
| 0 0 0 0 0 0 0 0 0 0 0 0 0 0 0 0 0 0 0 0 0 0 0 0 0 0 0 0 0 | 0 |

For generating O-sequences of length 32, 6 sequence matrices may be generated by this method. In one preferred embodiment, all six of these sequences are generated and stored in memory by each remote terminal and each base. Each word coded by each channel 208 is modulated by a different one of these six O-code sequences, in accordance with a predetermined, pseudo-random sequence. In this manner, each symbol is spread with a different O-code in a pseudo-random, noise-like manner that further enhances the interference rejection of the modulated transmission signal. It must also be noted that maximal length sequences are themselves pseudo-random, and thus noise-like, and thereby further introduce a degree of randomness and interference rejection in the symbols encoded with O-codes derived from them. For all of the above reasons, the interference rejection exhibited by the uplink design of the invention does not require the additional complexity and expense of being further spread by PN coding.

O-code sequences for use with the uplink of the invention may also be generated by using the Quadratic Residue sequence and its inverse. Thus, in this preferred embodiment, each remote terminal 14 and each base station 20 may each store eight sets (six sets generated from maximal sequences and two sets generated from quadratic residue sequences) of 32 sequences that are self-orthogonal; i.e. the cross-correlation between any two sequences of a set is zero.

In the first embodiment, a base station and its remote terminals are restricted to use only one of the eight sets. A system planner assigns which set each base station is to use. This scheme offers enhanced inter-base interference rejection because the cross-correlation between sequences from different sets is less than the cross-correlation between sequences from the same set, when there is a time shift (due to the propagation time between bases). The operation within each base is now described.

When a remote terminal 14 desires to transmit information on a reserved channel, it first requests a channel assignment from the base 20 using a contention-access channel. The base 20 responds with an assignment that includes both the TDMA time slot(s) granted and the logical channel(s) to be used during each TDMA time slot granted. A remote terminal may be assigned multiple channels during an individual TDMA time slot and each channel can be used to send 600 (for QPSK, rate-½) consecutive symbols during the time slot.

The remote terminal converts each logical channel assignment into a single physical channel that consists of a sequence of 600 rows (for QPSK) from the orthogonal set. Successive rows from the orthogonal set are chosen using a pseudo-random mapping. “Randomly” picking different rows for each of the 600 symbols greatly simplifies remote to base synchronization.

The pseudo-random mapping changes every 32 chip-intervals (a single symbol), and repeats at the frame rate. The base and all remote terminals use the same pseudo-random mapping so that the base station can reconstruct the information. In the example shown in Table 5, the base has assigned one logical channel to remote terminal #1, two logical channels to remote terminal #2, and one logical channel to remote terminal #3. The logical-channel assignments made by the base is constant during the TDMA slot, and the pseudo-random mapping changes the physical, or actual, channel sequence within the slot.

TABLE 5
Physical Channel Assignments During One TDMA Slot

| 32-chip | Remote #1 | Remote #2 | | Remote #3 |
|---|---|---|---|---|
| interval | Phy. Chan. | Phy. Chan. | Phy. Chan. | Phy. Chan. |
| 1^{st} | 13 | 21 | 2 | 11 |
| 2^{nd} | 22 | 6 | 15 | 31 |
| 3^{rd} | 1 | 31 | 10 | 12 |
| 4^{th} | 16 | 17 | 5 | 3 |
| 5^{th} | 29 | 23 | 18 | 24 |
| 600^{th} | 3 | 14 | 31 | 11 |

In an alternative embodiment, each remote and base station also stores the eight sets of 32 self-orthogonal sequences, as described previously. However, in addition to pseudo-randomly mapping the logical-to-physical channel assignments as above, in this embodiment each remote terminal also pseudo-randomly selects among the eight O-CDMA sequence sets. This selection is performed at the same time as the logical-to-physical mapping; i.e. every 32 chip-interval.

This embodiment provides inter-cell interference rejection that is nearly as good as the previously described embodiment and does not require a system planner to coordinate the cell assignments. An illustrative example is shown in Table 6.

TABLE 6
Physical Channel Assignments During One TDMA Slot

| | Remote #1 | | Remote #2 | | | | Remote #3 | |
|---|---|---|---|---|---|---|---|---|
| 32-chip | Seq. | Phy. | Seq. | Phy. | Seq. | Phy. | Seq. | Phy. |
| Interval | Set | Chan. | Set | Chan. | Set | Chan. | Set | Chan. |
| 1^{st} | 0 | 13 | 0 | 21 | 0 | 2 | 0 | 11 |
| 2^{nd} | 5 | 22 | 5 | 6 | 5 | 15 | 5 | 31 |
| 3^{rd} | 2 | 1 | 2 | 31 | 2 | 10 | 2 | 12 |
| 4^{th} | 7 | 16 | 7 | 17 | 7 | 5 | 7 | 3 |
| 5^{th} | 4 | 29 | 4 | 23 | 4 | 18 | 4 | 24 |
| 600^{th} | 1 | 3 | 1 | 14 | 1 | 31 | 1 | 11 |

Of course, simpler alternatives are also within the scope of the invention. For example, a single set of 32 orthogonal sequences may be provided for use by each network of remote terminals.

Uplink Synchronization Procedure

Referring now to FIG. 8, to maintain orthogonality among the uplink code channels 208, the remote terminals 14 must synchronize their uplink signals 27 so that the signals from all remote terminals arrive at the base station 20 aligned in time. This enables the base station to (i) correlate to the sequence, and (ii) eliminate the signals arriving from other remote terminals (i.e. all remote transmitted sequences arrive at the same time so that the orthogonality of the sequence can be used to eliminate interference between remote terminals). In the preferred embodiment, the base 20 measures the timing error of each uplink signal 27, and then sends the error information in a control message during the downlink segment 23 to the corresponding remote terminal 14. The remote terminal 14 uses the error information to adjust the time of its next transmission so that it arrives at the base 20 at the correct time. In order to reduce the frequency of making adjustments, each remote terminal 14 sets the frequency of its transmitting code clock to be equal to the downlink code clock frequency. Timing errors can be measured using the delay-lock discriminator method on the synchronization symbols corresponding to the uplink code channel and time slot.

Uplink synchronization is also aided by pseudo randomly choosing different orthogonal codes for each symbol transmitted, as described previously. This is the case because before starting the synchronization process, the time uncertainty, or interval of time in which the correct synchronization time exists, is larger than the duration of one sequence. In fact, a unique pattern with duration of one slot (or 600 sequence intervals; i.e. 600×32 chips) is preferred to identify the correct synchronization time. The preferred method of generating this pattern is to pseudo-randomly map the logical-to-physical channel because this can be implemented in hardware relatively simply.

Additional advantageous features of the invention include the use of high-order modulation methods leads to many bits being packed into each cycle of available spectrum; using power control on the uplink to operate each remote terminal 14 at no more than the amount of power needed for the given link conditions; synchronizing the downlink and uplink segments among all cells to reduce interference between adjacent bases 20; providing each base with a six-antenna sector antenna to increase capacity by reusing frequencies at each adjacent base; and using high-gain directional antennas to minimize interference.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A method of wideband communication between a base station and a plurality of remote terminals within each cell of a multi-cell network, comprising:
1) at each base station, processing a base input data signal for broadcast to remote terminals in the same cell by:
demultiplexing the base input data signal into a plurality of base channels;
modulating a portion of the base input data signal in each base channel;
time division multiplexing each modulated base channel within one or more data time periods to form a base output data signal;
spreading the base output data signal with a pseudo-random noise signal to form a broadcast signal;
broadcasting the broadcast signal to be received by the plurality of remote terminals within the same cell; and,
2) at each remote terminal, processing a terminal data signal for transmission to the base station in the same cell by:
demultiplexing the terminal data signal into one or more terminal channels;
modulating a portion of the terminal input data signal in each terminal channel;
spreading each modulated terminal channel with an orthogonal code to form an orthogonal signal;
summing a predetermined number of the orthogonal signals to form a terminal signal; and
scheduling the terminal signal for transmission by the remote terminal to be received by the base station in the same cell synchronously with terminal signals from other remote terminals in the same cell.

2. The method of claim 1, further comprising:
transmitting the terminal signal from each remote terminal to be received by the base station in the same cell synchronously with terminal signals from other remote terminals in the same cell.

3. The method of claim 2, wherein all orthogonal codes used to spread modulated terminal channels have zero cross- correlation with one another.

4. The method of claim 2, wherein all orthogonal codes used to spread modulated terminal channels have sufficiently low cross-correlation with one another to reject interfering signals from remote terminals in other cells.

5. The method of claim 4, wherein the orthogonal codes are selected pseudo-randomly for spreading the modulated terminal channels.

6. The method of claim 1, wherein summing a predetermined number of the orthogonal signals to form a terminal signal further comprises:
determining the predetermined number of orthogonal signals based upon the terminal data signal.

7. The method of claim 2, wherein broadcasting the broadcast signal and transmitting the terminal signal from each remote terminal further comprise:
broadcasting the broadcast signal from a base in a cell and transmitting the terminal signal from each remote terminal in the same cell on the same carrier frequency in a time division duplex scheme.

8. The method of claim 1, wherein time division multiplexing each modulated base channel within one or more data time periods to form a base output data signal further comprises:
time division multiplexing a predetermined number of the modulated base channels within each time period to form a plurality of data time periods.

9. The method of claim 8, wherein spreading the base output data signal with a pseudo-random noise signal to form a broadcast signal further comprises:
spreading each data time period with a pseudo-random noise signal to form PN-spread data time periods; and
scheduling the PN-spread data time periods for broadcasting in a time division multiple access scheme.

10. A wideband communication system for communicating between a base station and a plurality of remote terminals within each cell of a multi-cell network, comprising:
1) at each base station, logic for processing a base input data signal for broadcast to remote terminals in the same cell comprising:
a base demultiplexer for demultiplexing the base input data signal into a plurality of base channels;
a plurality of base modulators for modulating a portion of the base input data signal in each base channel;
a base multiplexer for time division multiplexing each modulated base channel within one or more data time periods to form a base output data signal;
a base multiplier for spreading the base output data signal with a pseudo-random noise signal to form a broadcast signal;
a RF system for broadcasting the broadcast signal to be received by the plurality of remote terminals within the same cell; and,
2) at each remote terminal, logic for processing a terminal data signal for transmission to the base station in the same cell comprising:
a terminal demultiplexer for demultiplexing the terminal data signal into one or more terminal channels;
a terminal modulator in each terminal channel for modulating a portion of the terminal input data signal in each respective terminal channel;
a terminal multiplier for spreading each modulated terminal channel with an orthogonal code to form an orthogonal signal;
a terminal adder for summing a predetermined number of the orthogonal signals to form a terminal signal; and
logic for scheduling the terminal signal for transmission by the remote terminal to be received by the base station in the same cell synchronously with terminal signals from other remote terminals in the same cell.

11. The system of claim 10, further comprising:
a transmitter at each remote terminal for transmitting the terminal signal from the respective remote terminal to be received by the base station in the same cell synchronously with terminal signals from other remote terminals in the same cell.

12. The system of claim 10, wherein the terminal multiplier for spreading each modulated terminal channel with an orthogonal code to form an orthogonal signal comprises:
a terminal multiplier using orthogonal codes having zero cross-correlation with one another to spread the modulated terminal channels to form an orthogonal signal.

13. The system of claim 10, wherein the terminal multiplier for spreading each modulated terminal channel with an orthogonal code to form an orthogonal signal comprises:
a terminal multiplier using orthogonal codes having sufficiently low cross-correlation with one another to reject interfering signals from remote terminals in other cells.

14. The system of claim 13, wherein the terminal multiplier comprises:
a terminal multiplier to pseudo-randomly select the orthogonal codes for spreading the modulated terminal channels.

15. The system of claim 10, wherein the terminal adder for summing a predetermined number of the orthogonal signals to form a terminal signal comprises:
a terminal adder for determining the predetermined number of orthogonal signals based upon the terminal data signal.

16. The system of claim 11, further comprising:
a time division duplex system at each base station in a cell for broadcasting the broadcast signal on a preselected carrier frequency; and
a time division duplex system at each remote terminal in the same cell for transmitting the terminal signal from each remote terminal in the respective cell on the preselected carrier frequency used by the base station in the respective cell.

17. The system of claim 10, wherein the base multiplexer for time division multiplexing each modulated base channel within one or more data time periods to form a base output data signal further comprises:
a base multiplexer for time division multiplexing a predetermined number of the modulated base channels within each time period to form a plurality of data time periods.

18. The system of claim 17, wherein the base multiplier for spreading the base output data signal with a pseudo-random noise signal to form a broadcast signal comprises:
a base multiplier for spreading each data time period with a pseudo-random noise signal to form PN-spread data time periods; and the base station further comprises:
a time division multiple access circuit for scheduling the PN-spread data time periods for broadcasting.
